(19) United States
(12) Patent Application Publication
(10) Pub. No.: US 2013/0049633 A1
(43) Pub. Date: Feb. 28, 2013

(54) ILLUMINATION SYSTEM RELATING TO LIGHT-EMITTING-DIODE LAMPS

(71) Applicants: Bao-Liin Wann, Taoyuan County (TW); Juan-Juan Sun, Nanjing (CN); Hai-Dan Zou, Nanjing (CN); Xiao-Qing Li, Nanjing (CN)

(72) Inventors: Bao-Liin Wann, Taoyuan County (TW); Juan-Juan Sun, Nanjing (CN); Hai-Dan Zou, Nanjing (CN); Xiao-Qing Li, Nanjing (CN)

(73) Assignees: FSP-POWERLAND TECHNOLOGY INC., Nanjing (CN); FSP TECHNOLOGY INC., Taoyuan County (TW)

(21) Appl. No.: 13/592,367

(22) Filed: Aug. 23, 2012

Related U.S. Application Data
(60) Provisional application No. 61/526,686, filed on Aug. 24, 2011.

(30) Foreign Application Priority Data
Aug. 16, 2012 (TW) 101129795

(51) Int. Cl. H05B 37/02

(52) U.S. Cl. 315/294

(57) ABSTRACT

An illumination system at least including a first light-emitting-diode (LED) lamp and a first driving device with a communication function is provided. The first driving device is coupled to the first LED lamp, and is configured to receive a first control signal corresponding to the first LED lamp via wired or wireless manner, and to accordingly provide a first working parameter of the first LED lamp. Therefore, in the invention, the first control signal can be generated by an electronic equipment with a communication function (for example, a smart phone, a notebook, or a tablet PC) included in the provided illumination system, so as to manipulate the first LED lamp via wired or wireless manner.

### CROSS-REFERENCE TO RELATED APPLICATION

This application claims the priority benefits of U.S. provisional application Ser. No. 61/526,686, filed on Aug. 24, 2011 and Taiwan application serial no. 101129795, filed on Aug. 16, 2012. The entirety of each of the above-mentioned patent applications is hereby incorporated by reference herein and made a part of this specification.

### BACKGROUND

1. Field of the Invention

The invention relates to an illumination technology, and more particularly to, an illumination system relating to light-emitting diode (LED) lamps.

2. Description of Related Art

Light-emitting diode (LED) lamps respectively researched and developed by different manufacturers have corresponding dimming controllers. In most basic low-level applications, the dimming controller of each LED lamp is generally embedded on the wall, such that the dimming controller must be within the reach of the user in order to manipulate the LED lamp. Moreover, in some high-level applications, the dimming controllers for certain LED lamps further have remote control functions for forming remote control dimmers. However, not only these remote control dimmers have high cost, but also these remote control dimmers are not compatible with one another.

### SUMMARY OF THE INVENTION

Accordingly, in order to solve the problem described in the “Related Art”, an exemplary embodiment of the invention provides an illumination system including a first light-emitting-diode lamp and a first driving device with a communication function. The first driving device is coupled to the first light-emitting-diode lamp, and is configured to receive a first control signal corresponding to the first light-emitting-diode lamp via wired or wireless manner, and accordingly provide a first working parameter of the first light-emitting-diode lamp.

In an exemplary embodiment of the invention, the illumination system may further include an electronic equipment with a communication function and having a built-in interactive application. In this case, the electronic equipment may receive a first user input command in response to an activation of the interactive application, and convert the first user input command to generate the first control signal. Moreover, the electronic equipment may transmit the first control signal to the first driving device via wired or wireless manner.

In an exemplary embodiment of the invention, the illumination system may further include a second light-emitting diode lamp and a second driving device with a communication function. The second driving device is coupled to the second light-emitting diode lamp, and is configured to receive a second control signal corresponding to the second light-emitting diode lamp via wired or wireless manner, and to accordingly provide a second working parameter of the second light-emitting diode lamp.

In an exemplary embodiment of the invention, the electronic equipment may further receive a second user input command in response to the activation of the interactive application, and convert the second user input command to generate the second control signal. Moreover, the electronic equipment may further transmit the second control signal to the second driving device via wired or wireless manner.

In an exemplary embodiment of the invention, the electronic equipment may be a smart phone, a notebook, or a tablet PC. In this case, the electronic equipment may communicate with the first driving device and/or the second driving device at least via a Bluetooth wireless transmission, a WiFi wireless transmission, a WiMAX wireless transmission, a Zigbee wireless transmission, an infrared ray wireless transmission, a USB wired transmission, or a combination therebetween.

In an exemplary embodiment of the invention, the first user input command and/or the second user input command may at least include at least one of a voice command, a touch command, a gesture command, and a direction (gravity) sensing command.

In an exemplary embodiment of the invention, the first driving device is capable of being integrated into a power module of the first light-emitting-diode lamp; and the second driving device is capable of being integrated into a power module of the second light-emitting diode lamp.

In an exemplary embodiment of the invention, the activated interactive application may be further configured to assign corresponding wireless network IP addresses to the first and the second light-emitting diode lamps through a wireless Internet, such that at least one of the first and the second light-emitting diode lamps to be manipulated is selected via the electronic equipment for setting.

In an exemplary embodiment of the invention, the first and the second light-emitting diode lamps may be two original wireless network devices within a service range covered by a wireless network equipment (e.g. Bluetooth network access-point, but not limited thereto), and when the electronic equipment becomes as a new wireless network device within the service range covered by the wireless network equipment, the electronic equipment is firstly connected to the wireless network equipment, and then connected, via the wireless network equipment, to at least one of the first and the second light-emitting diode lamps to be manipulated for setting.

From the above, any electronic equipment (e.g., the smart phone, the notebook, or the tablet PC) with a certain wired or wireless communication specification can be operated by the user to generate the corresponding control signals for manipulating, via wired or wireless manner, different light-emitting diode lamps each having the same wired or wireless communication specification as the operated electronic equipment. As a result, the invention can effectively solve the problem described in the “Related Art”.

In order to make the aforementioned and other features and advantages of the invention comprehensible, several exemplary embodiments accompanied with figures are described in detail below.

However, the general descriptions in the above and the following embodiments below are only illustrative and interpretative examples, and the scope of the invention is not limited thereto.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic diagram of an illumination system 10 according to an exemplary embodiment of the invention.

FIG. 2A illustrates a schematic diagram of a driving device 103-1 with a communication function illustrated in FIG. 1.

FIG. 2B illustrates a schematic diagram of a driving device 103-2 with a communication function illustrated in FIG. 1.

FIG. 3 illustrates a schematic diagram of an illumination system 10′ according to another exemplary embodiment of the invention.

FIG. 4 illustrates a schematic diagram of a driving device 103 with a communication function illustrated in FIG. 3.

FIG. 5A is an application diagram according to an exemplary embodiment of the invention.

FIG. 5B is another application diagram according to another exemplary embodiment of the invention.

### DETAILED DESCRIPTION OF DISCLOSED EMBODIMENTS

The following is to explain the exemplary embodiments illustrated in the drawings with detailed reference to the exemplary embodiments of the invention.

Moreover, wherever it is possible, elements/components using the same labels in the drawings and in the embodiments represent the same or similar parts.

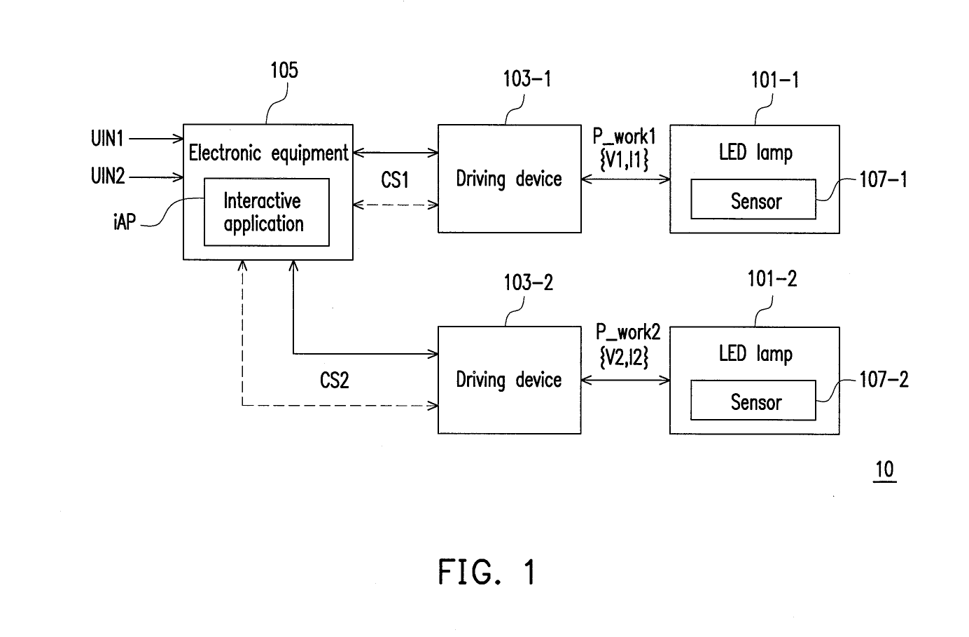

FIG. 1 illustrates a schematic diagram of an illumination system 10 according to an exemplary embodiment of the invention. Referring to FIG. 1, the illumination system 10 at least includes light-emitting diode (LED) lamps 101-1 and 101-2, driving devices 103-1 and 103-2 each with a communication function, and an electronic equipment 105 with a communication function and having a built-in interactive application iAP. Moreover, sensors 107-1 and 107-2 configured to sense the states of the lamps are respectively disposed in the LED lamps 101-1 and 101-2.

In the exemplary embodiment, the electronic equipment 105 may be a smart phone, a notebook or a tablet PC, but not limited thereto. Additionally, the electronic equipment 105 may communicate with the driving device 103-1 and/or the driving device 103-2 at least via Bluetooth wireless transmission, WiFi wireless transmission, WiMAX wireless transmission, Zigbee wireless transmission, infrared ray wireless transmission, USB wired transmission, or a combination therebetween, but not limited thereto.

The electronic equipment 105 may receive, in response to an activation of the interactive application iAP, an external user input command UIN1, and convert the received user input command UIN1 to generate a control signal CS1. In the exemplary embodiment, the user input command UIN1 may be a touch command and/or a voice command and/or a gesture command and/or a directional (gravity) sensing command (viz. at least one of the voice command, the touch command, the gesture command, and the direction (gravity) sensing command, but not limited thereto, where the directional (gravity) sensing command may be generated from a multi-axis sensing device (for example, a gyroscope or an accelerator meter) or an optical sensing device). In addition, the electronic equipment 105 may transmit the generated control signal CS1 to the driving device 103-1 via wired or wireless manner. In this case, the driving device 103-1 with the communication function is coupled to the LED lamp 101-1, and is configured to receive the control signal CS1 which is from the electronic equipment 105 and corresponding to the LED lamp 101-1 via wired or wireless manner, and to accordingly provide a working parameter P_work1 of the LED lamp 101-1 (e.g., an adjustable working voltage V1 and an adjustable working current I1 of the LED lamp 101-1).

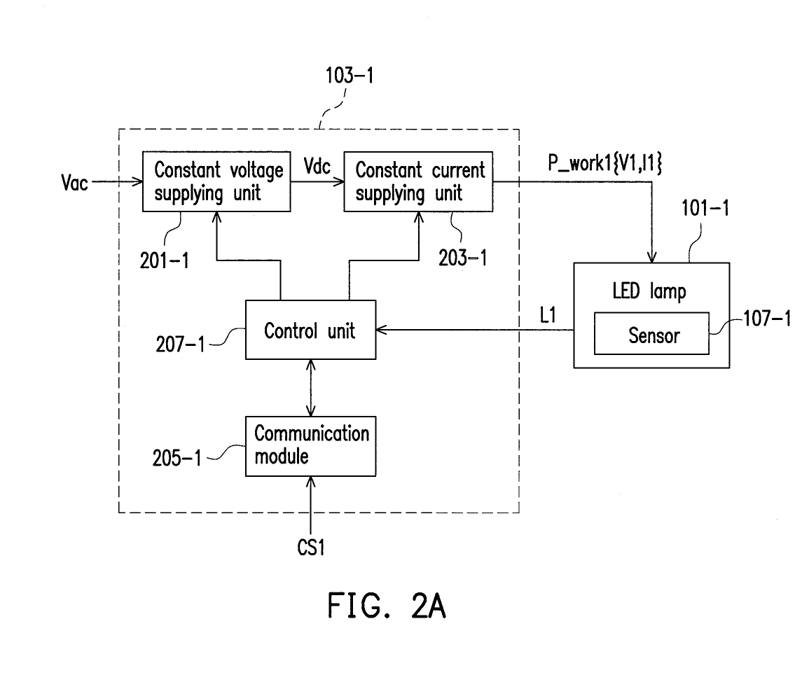

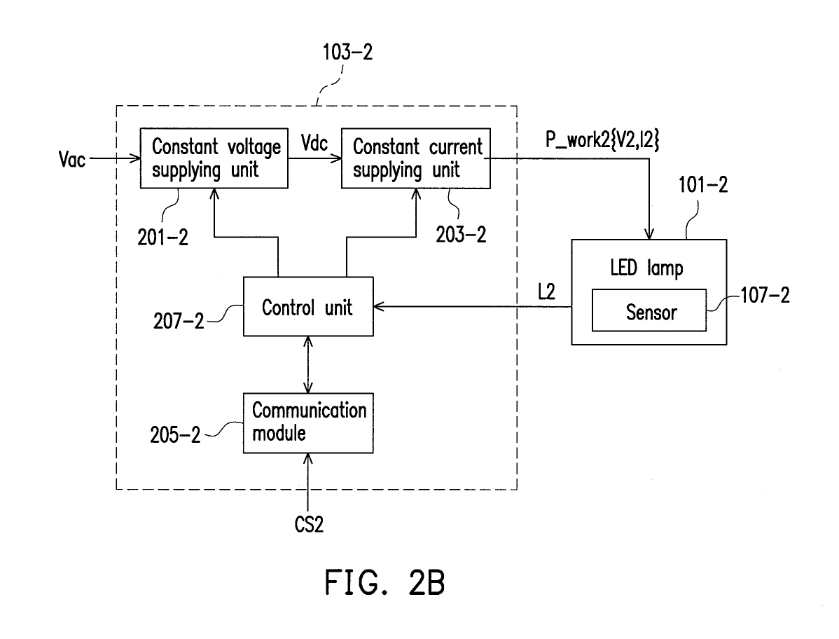

More specifically, FIG. 2A illustrates a schematic diagram of the driving device 103-1 with the communication function illustrated in FIG. 1. Referring to FIGS. 1 and 2A, the driving device 103-1 includes a constant voltage supplying unit 201-1, a constant current supplying unit 203-1, a communication module 205-1, and a control unit 207-1.

The constant voltage supplying unit 201-1 is configured to receive an AC voltage Vac, and to convert (e.g., AC-DC conversion) the received AC voltage Vac to provide a DC constant voltage Vdc. In the present exemplary embodiment, the constant voltage supplying unit 201-1 may be constituted of a bridge rectifier and a flyback converter, but not limited thereto.

The constant current supplying unit 203-1 is configured to receive the DC constant voltage Vdc from the constant voltage supplying unit 201-1, and to convert (e.g., DC-DC conversion) the received DC constant voltage Vdc to provide the adjustable working voltage V1 and the adjustable working current I1 of the LED lamp 101-1. In the present exemplary embodiment, the constant current supplying unit 203-1 may be implemented by a buck conversion circuit, but not limited thereto.

The communication module 205-1 is configured to receive the control signal CS1 from the electronic equipment 105 via wired or wireless manner. In the present exemplary embodiment, the communication module 205-1 may be any type of wired communication module (e.g., a USB communication module, but not limited thereto), or any type of wireless communication module (e.g., Bluetooth wireless communication module, WiFi wireless communication module, WiMAX wireless communication module, Zigbee wireless communication module, or infrared ray wireless communication module, but not limited thereto).

The control unit 207-1 is coupled to the constant voltage supplying unit 201-1, the constant current supplying unit 203-1 and the communication module 205-1, and is configured to control operations of the constant voltage supplying unit 201-1 and the constant current supplying unit 203-1 in response to the control signal CS1 received by the communication module 205-1. In the present exemplary embodiment, the control unit 207-1 may control the operations of the constant voltage supplying unit 201-1 and the constant current supplying unit 203-1 by adopting an analog manner and/or a digital manner, so that an analog, a digital or a pulse width modulation (PWM) dimming of the LED lamp 101-1 may be achieved.

For example, depending on the actual design, the control unit 207-1 may control the operations of the constant voltage supplying unit 201-1 and the constant current supplying unit 203-1 by simultaneously adopting the digital manner; or the control unit 207-1 may control the operations of the constant voltage supplying unit 201-1 and the constant current supplying unit 203-1 by respectively adopting the digital manner and the analog manner; or the control unit 207-1 may control the operations of the constant voltage supplying unit 201-1 and the constant current supplying unit 203-1 by respectively adopting the analog manner and the digital manner.

In addition, the sensor 107-1 in the LED lamp 101-1 is configured to sense a state of the LED lamp 101-1, and to accordingly provide a state parameter L1 of the LED lamp 101-1 to the control unit 207-1. The sensor 107-1 in the LED lamp 101-1 and the control unit 207-1 may communicate with each other via digital manner. In this case, the control unit 207-1 may transmit, through the communication module 205-1, the received state parameter L1 to the electronic equipment 105 via wired or wireless manner, so as to make that the electronic equipment 105 is capable of (instantaneously) monitoring the (current) state (e.g., operation time, brightness, color temperature, ON/OFF, etc) of the LED lamp 101-1.

On the other hand, the electronic equipment 105 may further, in response to the activation of the interactive application iAP, receive an external user input command UIN2, and convert the received user input command UIN2 to generate a control signal CS2. The user input command UIN2 may be a touch command and/or a voice command and/or a gesture command and/or a directional (gravity) sensing command (viz. at least one of the voice command, the touch command, the gesture command, and the direction (gravity) sensing command, but not limited thereto). In addition, the electronic equipment 105 may transmit the generated control signal CS2 to the driving device 103-2 via wired or wireless manner. In this case, the driving device 103-2 with the communication function is coupled to the LED lamp 101-2, and is configured to receive the control signal CS2 which is from the electronic equipment 105 and corresponding to the LED lamp 101-1 via wired or wireless manner, and to accordingly provide a working parameter P_work2 of the LED lamp 101-2 (e.g., an adjustable working voltage V2 and an adjustable working current I2 of the LED lamp 101-2).

More specifically, FIG. 2B illustrates a schematic diagram of the driving device 103-2 with the communication function illustrated in FIG. 1. Referring to FIGS. 1, 2A and 2B, the configuration of the driving device 103-2 is similar to that of the driving device 103-1, and the driving device 103-2 includes a constant voltage supplying unit 201-2, a constant current supplying unit 203-2, a communication module 205-2, and a control unit 207-2.

The constant voltage supplying unit 201-2 is configured to receive the AC voltage Vac, and to convert (e.g., AC-DC conversion) the received AC voltage Vac to provide the DC constant voltage Vdc. Similarly, the constant voltage supplying unit 201-2 may be constituted of the bridge rectifier and the flyback converter, but not limited thereto.

The constant current supplying unit 203-2 is configured to receive the DC constant voltage Vdc from the constant voltage supplying unit 201-2, and to convert (e.g., DC-DC conversion) the received DC constant voltage Vdc to provide the adjustable working voltage V2 and the adjustable working current I2 of the LED lamp 101-2. Similarly, the constant current supplying unit 203-1 may be implemented by the buck conversion circuit, but not limited thereto.

The communication module 205-2 is configured to receive the control signal CS2 from the electronic equipment 105 via wired or wireless manner. Similarly, the communication module 205-2 may be any type of wired communication module (e.g., the USB communication module, but not limited thereto), or any type of wireless communication module (e.g., Bluetooth wireless communication module, WiFi wireless communication module, WiMAX wireless communication module, Zigbee wireless communication module, or infrared ray wireless communication module, but not limited thereto).

The control unit 207-2 is coupled to the constant voltage supplying unit 201-2, the constant current supplying unit 203-2 and the communication module 205-2, and is configured to control operations of the constant voltage supplying unit 201-2 and the constant current supplying unit 203-2 in response to the control signal CS2 received by the communication module 205-2. Similarly, the control unit 207-2 may control the operations of the constant voltage supplying unit 201-2 and the constant current supplying unit 203-2 by adopting an analog manner and/or a digital manner, so that an analog, a digital or a pulse width modulation (PWM) dimming of the LED lamp 101-2 may be achieved.

For example, depending on the actual design, the control unit 207-2 may control the operations of the constant voltage supplying unit 201-2 and the constant current supplying unit 203-2 by simultaneously adopting the digital manner; or the control unit 207-2 may control the operations of the constant voltage supplying unit 201-2 and the constant current supplying unit 203-2 by respectively adopting the digital manner and the analog manner; or the control unit 207-2 may control the operations of the constant voltage supplying unit 201-2 and the constant current supplying unit 203-2 by respectively adopting the analog manner and the digital manner.

In addition, the sensor 107-2 in the LED lamp 101-2 is configured to sense a state of the LED lamp 101-2, and to accordingly provide a state parameter L2 of the LED lamp 101-2 to the control unit 207-2. The sensor 107-2 in the LED lamp 101-2 and the control unit 207-2 may communicate with each other via digital manner. In this case, the control unit 207-2 may transmit, through the communication module 205-2, the received state parameter L2 to the electronic equipment 105 via wired or wireless manner, so as to make that the electronic equipment 105 is capable of (instantaneously) monitoring the (current) state (e.g., operation time, brightness, color temperature, ON/OFF, etc) of the LED lamp 101-2.

From the above, when the electronic equipment 105 is operated by the user to execute/activate the built-in interactive application iAP, a graphical virtual control interface attributed exclusively to the LED lamps 101-1 and 101-2 is displayed on the screen of the electronic equipment 105. Accordingly, the user may simultaneously or respectively manipulate/remote control the LED lamps 101-1 and 101-2 by simply performing a touch and/or voice and/or gesture and/or directional (gravity) sensing setting via the electronic equipment 105.

In other words, when the interactive application iAP built in the electronic equipment 105 is executed/activated, the electronic equipment 105 may simultaneously be considered as a virtual remote control dimmer of the LED lamps 101-1 and 101-2, so as to simultaneously or respectively manipulate/remote control the LED lamps 101-1 and 101-2.

For example, when the interactive application iAP built in the electronic equipment 105 is executed/activated, according to demands, the user may input (e.g., via a touch and/or a voice and/or a gesture and/or a directional (gravity) sensing manner) the desired user input command UIN1 (e.g., the ON/OFF, the brightness, the color temperature, the time, the dimming method of LED lamp 101-1) for manipulating the LED lamp 101-1 through the electronic equipment 105.

Once the desired user input command UIN1 for manipulating the LED lamp 101-1 is input by the user through the electronic equipment 105, the electronic equipment 105 may convert the user input command UIN1 input by the user through the activated interactive application iAP to generate the control signal CS1, and transmit the generated control signal CS1 to the driving device 103-1 via wired or wireless manner (e.g., Bluetooth wireless transmission, but not limited thereto).

Once the communication module 205-1 receives/obtains the control signal CS1 from the electronic equipment 105 via wired or wireless manner (e.g., Bluetooth wireless transmission, but not limited thereto), the control unit 207-1 would control the operations of the constant voltage supplying unit 201-1 and the constant current supplying unit 203-1 in response to the control signal CS1 received by the communication module 205-1, so as to control the constant voltage supplying unit 201-1 to provide the DC constant voltage Vdc, and to control the constant current supplying unit 203-1 to provide the adjustable working voltage V1 and the adjustable working current I1 of the LED lamp 101-1. Here, by controlling the constant current supplying unit 203-1, the analog, the digital or the pulse width modulation (PWM) dimming of the LED lamp 101-1 can be achieved by the control unit 207-1.

Similarly, when the interactive application iAP built in the electronic equipment 105 is executed/activated, according to demands, the user may input (e.g., via a touch and/or a voice and/or a gesture and/or a directional (gravity) sensing manner) the desired user input command UIN2 (e.g., the ON/OFF, the brightness, the color temperature, the time, the dimming method of LED lamp 101-2) for manipulating the LED lamp 101-2 through the electronic equipment 105.

Once the desired user input command UIN2 for manipulating the LED lamp 101-2 through the electronic equipment 105 is input by the user, the electronic equipment 105 may convert the user input command UIN2 input by the user through the activated interactive application iAP to generate the control signal CS2, and transmit the generated control signal CS2 to the driving device 103-2 via wired or wireless manner (e.g., Bluetooth wireless transmission, but not limited thereto).

Once the communication module 205-2 receives/obtains the control signal CS2 from the electronic equipment 105 via wired or wireless manner (e.g., Bluetooth wireless transmission, but not limited thereto), the control unit 207-2 would control the operations of the constant voltage supplying unit 201-2 and the constant current supplying unit 203-2 in response to the control signal CS2 received by the communication module 205-2, so as to control the constant voltage supplying unit 201-2 to provide the DC constant voltage Vdc, and to control the constant current supplying unit 203-2 to provide the adjustable working voltage V2 and the adjustable working current I2 of the LED lamp 101-2. Here, by controlling the constant current supplying unit 203-2, the analog, the digital or the pulse width modulation (PWM) dimming of the LED lamp 101-2 can be achieved by the control unit 207-2.

Obviously, any electronic equipment 105 (e.g., the smart phone, the notebook, or the tablet PC) with a certain wired or wireless communication specification (e.g., Bluetooth, but not limited thereto) can be operated by the user to generate the corresponding control signals CS1/CS2 for manipulating, via wired or wireless manner, different LED lamps 101-1/101-2 each having the same wired or wireless communication specification (viz. Bluetooth) as the operated electronic equipment 105. In other words, under the condition that both the communication modules 205-1 and 205-2 in the driving devices 103-1 and 103-2 are Bluetooth communication modules, since the Bluetooth communication modules have an automatic matching function within an effective distance, the same electronic equipment 105 may remote control different driving devices 103-1 and 103-2 flexibly at different locations, so that the purpose of synchronously or asynchronously manipulating the LED lamps 101-1 and 101-2 can be achieved.

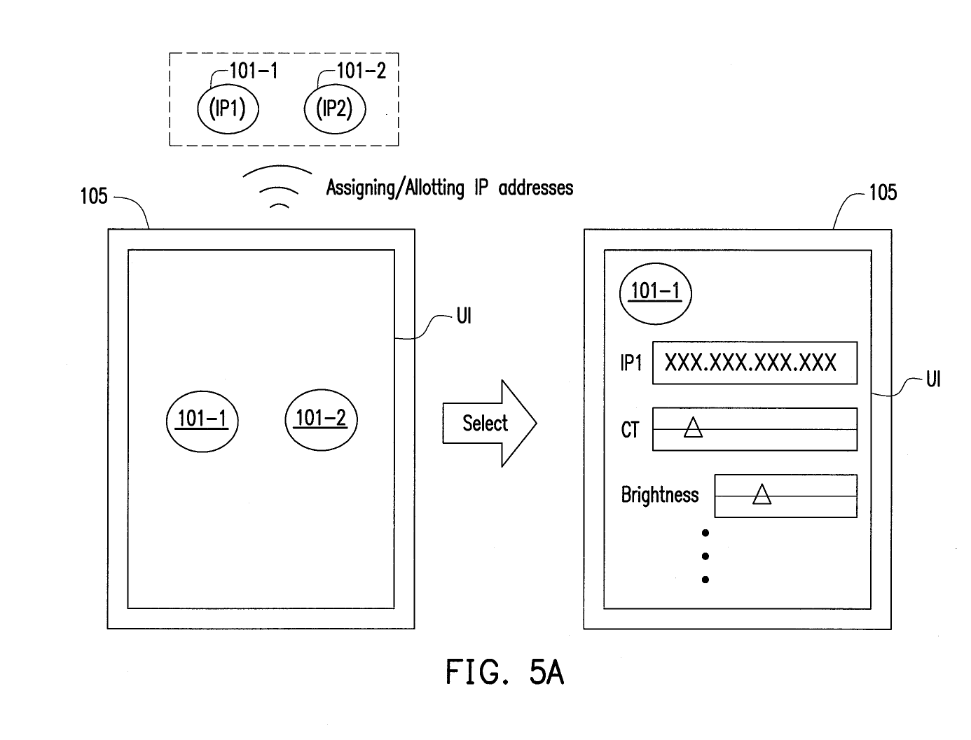

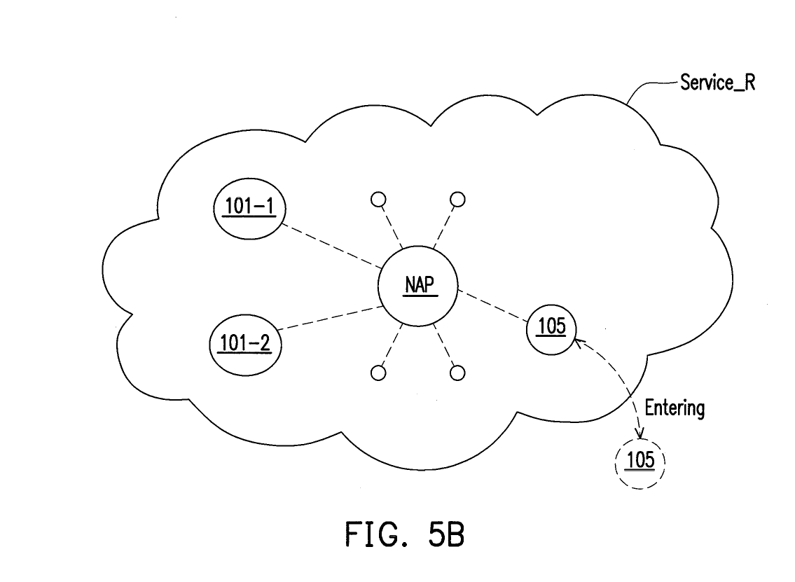

It is noted that, in some practice applications, as shown in FIG. 5A, the executed/activated interactive application (APP) iAP built-in the electronic equipment 105 may be further configured to assign/allot corresponding wireless network IP addresses (IP1, IP2) to the same group of all LED lamps 101-1 and 101-2 through wireless Internet (for example, Bluetooth Internet, but not limited thereto), such that each of the LED lamps 101-1 and 101-2 has a unique wireless network IP address. In this case, at least one of the LED lamps 101-1 (IP1) and 101-2 (IP2) to be manipulated can be selected by user via the graphical virtual control interface (UI) displayed on the screen of the electronic equipment 105 for setting (e.g., the ON/OFF, the brightness, the color temperature (CT), the time, the dimming method of LED lamps 101-1/101-2).

Even, in some practice applications, as shown in FIG. 5B, all LED lamps 101-1 and 101-2 can be seen as the same group or different groups, and can be seen as the original wireless network devices within the service range Service_R covered by a certain wireless network equipment such as a Bluetooth network access-point (NAP), but not limited thereto. In this case, once the electronic equipment 105 enters into the service range Service_R covered by the Bluetooth network AP (NAP), the electronic equipment 105 would become as a new wireless network device within the service range Service_R covered by the Bluetooth network AP (NAP), such that the electronic equipment 105 can be firstly connected to the Bluetooth network AP (NAP) by user, and then connected, via the Bluetooth network AP (NAP), to at least one of the LED lamps 101-1 and 101-2 to be manipulated for setting (e.g., the ON/OFF, the brightness, the color temperature, the time, the dimming method of LED lamps 101-1/101-2).

In addition, since the sensor 107-1 configured to sense the state of the lamp is disposed in the LED lamp 101-1, and moreover, the sensor 107-1 may digitally communicate with the control unit 207-1, the control unit 207-1 may transmit, through the communication module 205-1, the state parameter L1 from the sensor 107-1 to the electronic equipment 105 via wired or wireless manner, so as to make that the electronic equipment 105 is capable of (instantaneously) monitoring the state of the LED lamp 101-1 under the condition that the electronic equipment 105 is to monitor the state of the LED lamp 101-1.

Similarly, since the sensor 107-2 configured to sense the lamp state is disposed in the LED lamp 101-2, and moreover, the sensor 107-2 may digitally communicate with the control unit 207-2, the control unit 207-2 may transmit, through the communication module 205-2, the state parameter L2 from the sensor 107-2 to the electronic equipment 105 via wired or wireless manner, so as to make that the electronic equipment 105 is capable of (instantaneously) monitoring the state of the LED lamp 101-2 under the condition that the electronic equipment 105 is to monitor the state of the LED lamp 101-2.

On the other hand, the above-mentioned exemplary embodiment is described, as an example, with a single driving device corresponding to a single LED lamp, namely, the driving device 103-1 is only corresponding to the LED lamp 101-1, and the driving device 103-2 is only corresponding to the LED lamp 101-2, but the invention is not limited thereto. In other words, in other exemplary embodiments of the invention, a single driving device may be corresponding to two or more LED lamps.

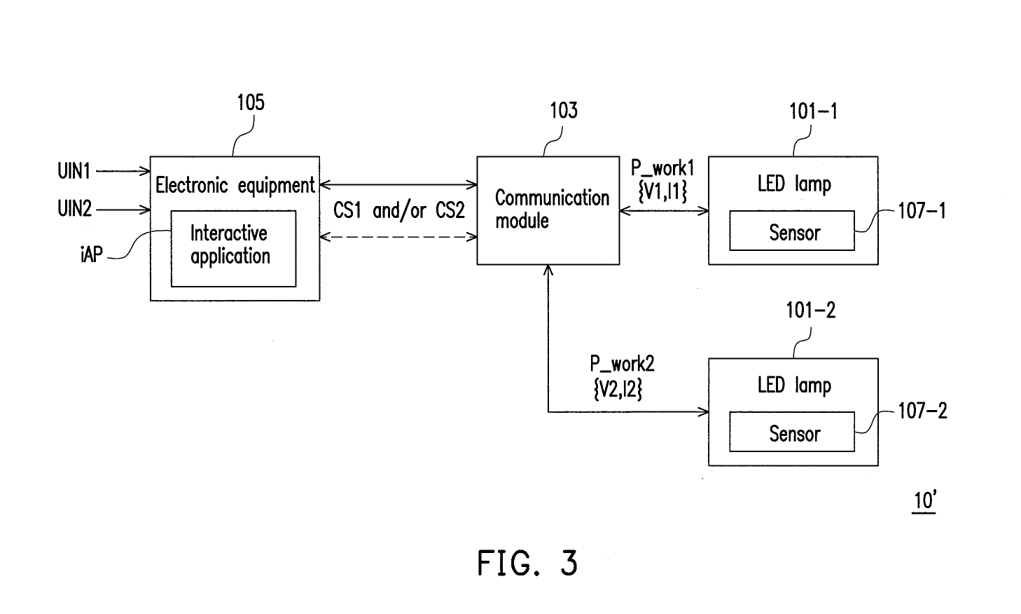

More specifically, FIG. 3 illustrates a schematic diagram of an illumination system 10′ according to another exemplary embodiment of the invention. Referring to FIG. 3, the illumination system 10′ at least includes LED lamps 101-1 and 101-2, a driving device 103 with a communication function, and an electronic equipment 105 with a communication function and having a built-in interactive application iAP. Similarly, sensors 107-1 and 107-2 configured to sense the states of the lamps are respectively disposed in the LED lamp 101-1 and 101-2.

In the present exemplary embodiment, the electronic equipment 105 may be a smart phone, a notebook or a tablet PC, but not limited thereto. Moreover, the electronic equipment 105 may communicate with the driving device 103 at least via Bluetooth wireless transmission, WiFi wireless transmission, WiMAX wireless transmission, Zigbee wireless transmission, infrared ray wireless transmission, USB wired transmission, or a combination therebetween, but not limited thereto.

The electronic equipment 105 may receive, in response to the activation of the interactive application iAP, an external user input command UIN1 and/or an external user input command UIN2, and convert the received user input command UIN1 and/or the received user input command UIN2 to generate a control signal CS1 and/or a control signal CS2. In the exemplary embodiment, the user input command UIN1 and/or the user input command UIN2 may be a touch command and/or a voice command and/or a gesture command and/or a directional (gravity) command, but not limited thereto). Moreover, the electronic equipment 105 may transmit the generated control signal CS1 and/or the generated control signal CS2 to the driving device 103 via wired or wireless manner.

In this case, the driving device 103 with the communication function is coupled to the LED lamps 101-1 and 101-2, and is configured to receive the control signal CS1 and/or the control signal CS2 which is/are from the electronic equipment 105 and corresponding to the LED lamp 101-1 and/or the LED lamp 101-2 via wired or wireless manner, and to accordingly provide a working parameter P_work1 (e.g., an adjustable working voltage V1 and an adjustable working current I1 of the LED lamp 101-1) and/or a working parameter P_work2 (e.g., an adjustable working voltage V2 and an adjustable working current I2 of the LED lamp 101-2) of the LED lamp 101-1 and/or the LED lamp 101-2.

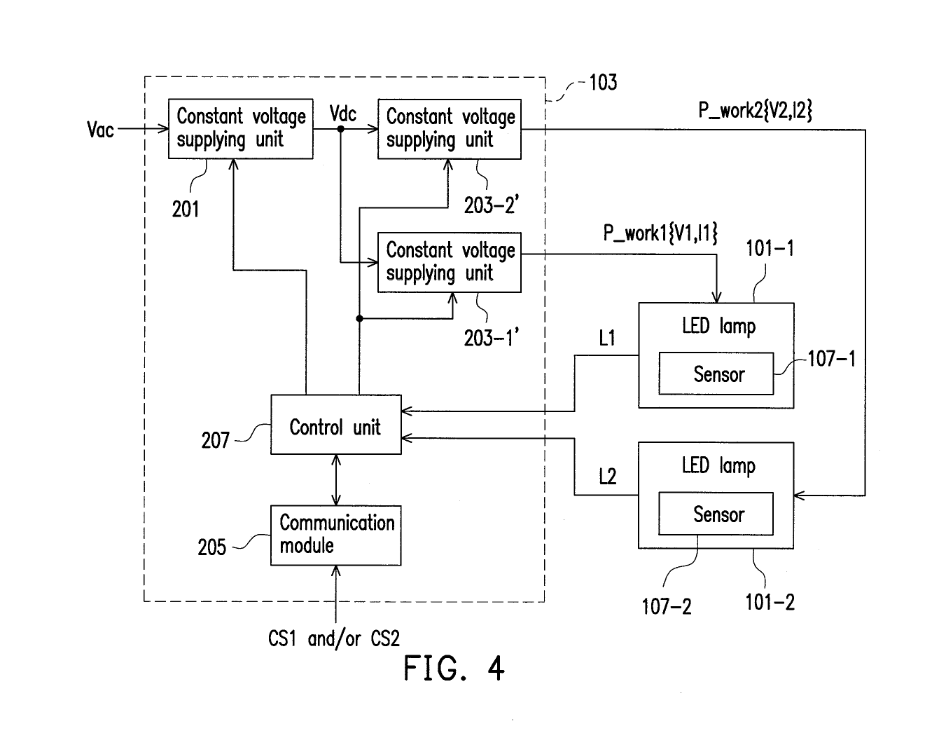

More specifically, FIG. 4 illustrates a schematic diagram of the driving device 103 with the communication function illustrated in FIG. 3. Referring to FIGS. 3 and 4, the driving device 103, as shown in FIG. 4, includes a constant voltage supplying unit 201, constant current supplying units 203-1′ and 203-2′, a communication module 205, and a control unit 207.

The constant voltage supplying unit 201 is configured to receive an AC voltage Vac, and to convert (e.g., AC-DC conversion) the AC voltage Vac to provide a DC constant voltage Vdc. In the present exemplary embodiment, the constant voltage supplying unit 201 may be constituted of a bridge rectifier and a flyback converter, but not limited thereto.

The constant current supplying unit 203-1′ is configured to receive the DC constant voltage Vdc from the constant voltage supplying unit 201, and to convert (e.g., DC-DC conversion) the received DC constant voltage Vdc to provide the adjustable working voltage V1 and the adjustable working current I1 of the LED lamp 101-1. Moreover, the constant current supplying unit 203-2′ is configured to receive the DC constant voltage Vdc from the constant voltage supplying unit 201, and to convert (e.g., DC-DC conversion) the received DC constant voltage Vdc to provide the adjustable working voltage V2 and the adjustable working current I2 of the LED lamp 101-2. In the present exemplary embodiment, each of the constant current supplying units 203-1′ and 203-2′ may be implemented by a buck conversion circuit, but not limited thereto.

The communication module 205 is configured to receive the control signal CS1 and/or the control signal CS2 from the electronic equipment 105 via wired or wireless manner. In the present exemplary embodiment, the communication module 205 may be any type of wired communication module (e.g., USB communication module, but not limited thereto), or any type of wireless communication module (e.g., Bluetooth wireless communication module, WiFi wireless communication module, WiMAX wireless communication module, Zigbee wireless communication module, or infrared ray wireless communication module, but not limited thereto).

The control unit 207 is coupled to the constant voltage supplying unit 201, the constant current supplying units 203-1′ and 203-2′, and the communication module 205, and is configured to control the operations of the constant voltage supplying unit 201 and the constant current supplying units 203-1′ and/or 203-2′ in response to the control signal CS1 and/or the control signal CS2 received by the communication module 205. In the present exemplary embodiment, the control unit 207 may control the operations of the constant voltage supplying unit 201 and the constant current supplying units (203-1′, 203-2′) by adopting an analog manner and/or a digital manner, so that an analog, a digital or a pulse width modulation (PWM) dimming of the LED lamp 101-1 and/or the LED lamp 101-2 may be achieved.

For example, depending on the actual design, the control unit 207 may control the operations of the constant voltage supplying unit 201 and the constant current supplying units (203-1′, 203-2′) by simultaneously adopting the digital manner; or the control unit 207 may control the operations of the constant voltage supplying unit 201 and the constant current supplying units (203-1′, 203-2′) by respectively adopting the digital manner and the analog manner; or the control unit 207 may control the operations of the constant voltage supplying unit 201 and the constant current supplying units (203-1′, 203-2′) by respectively adopting the analog manner and the digital manner.

Similarly, by controlling the constant current supplying units (203-1′, 203-2′), the analog, the digital or the pulse width modulation (PWM) dimming of the LED lamps (101-1, 101-2) can be achieved by the control unit 207.

In addition, the sensor 107-1 in the LED lamp 101-1 is configured to sense a state of the LED lamp 101-1, and to accordingly provide a state parameter L1 of the LED lamp 101-1 to the control unit 207. The sensor 107-1 in the LED lamp 101-1 and the control unit 207 may communicate with each other via digital manner. In this case, the control unit 207 may transmit, through the communication module 205, the received state parameter L1 to the electronic equipment 105 via wired or wireless manner, so as to make that the electronic equipment 105 is capable of (instantaneously) monitoring the (current) state (e.g., operation time, brightness, color temperature, ON/OFF, etc) of the LED lamp 101-1.

Similarly, the sensor 107-2 in the LED lamp 101-2 is configured to sense a state of the LED lamp 101-2, and to accordingly provide a state parameter L2 of the LED lamp 101-2 to the control unit 207. The sensor 107-2 in the LED lamp 101-2 and the control unit 207 may communicate with each other via digital manner. In this case, the control unit 207 may transmit, through the communication module 205, the received state parameter L2 to the electronic equipment 105 via wired or wireless manner, so as to make that the electronic equipment 105 is capable of (instantaneously) monitoring the (current) state (e.g., operation time, brightness, color temperature, ON/OFF, etc) of the LED lamp 101-2.

In other words, the control unit 207 may transmit, through the communication module 205, the received state parameter L1 and/or the received state parameter L2 to the electronic equipment 105 via wired or wireless manner, so as to make that the electronic equipment 105 is capable of (instantaneously) monitoring the (current) state of the LED lamp 101-1 and/or the (current) state of the LED lamp 101/2.

It is to know that the driving device 103 may be applied in the application of driving two LED lamps (101-1, 101-2) under a configuration/condition of having a single constant voltage supplying unit 201. Certainly, based on the contents in this disclosure, those skilled in the art should be able to self-deduce/analogize the implementations of using the driving device 103 to simultaneously drive three or more LED lamps, by simply disposing three or more additional the constant current supplying units controlled by the control units 207 in the driving device 103, and thus the detailed description would be omitted herein.

Noteworthily, depending on the actual design/application requirement, the driving devices (103, 103-1, 103-2) in each exemplary embodiments above may be capable of being integrated into the exclusive power modules of the LED lamps (101-1, 101-2). Certainly, the driving devices (103, 103-1, 103-2) in each exemplary embodiment above may be capable of being partially integrated.

Furthermore, in other exemplary embodiments of the invention, the sensors (107-1, 107-2) disposed in the LED lamps (101-1, 101-2) may further be configured with a voice recognition function. Therefore, the user may (directly) manipulate the LED lamps (101-1, 101-2) via the voice input manner. Or, the sensors (107-1, 107-2) disposed in the LED lamps (101-1, 101-2) may further be configured with a gesture recognition function. Therefore, the user may (directly) manipulate the LED lamps (101-1, 101-2) via the gesture input manner. Furthermore, the sensors (107-1, 107-2) disposed in the LED lamps (101-1, 101-2) may further be configured with a directional (gravity) sensing recognition function. Therefore, the user may (directly) manipulate the LED lamps (101-1, 101-2) by tilting, shaking, or changing the directions of the LED lamps (101-1, 101-2).

In summary, any electronic equipment (e.g., the smart phone, the notebook, or the tablet PC) with a certain wired or wireless communication specification can be operated by the user to generate the corresponding control signals for manipulating, via wired or wireless manner, different LED lamps each having the same wired or wireless communication specification as the operated electronic equipment, and further for monitoring the states of all LED lamps.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

Moreover, any embodiment or scope of the invention is not required to achieve all the objectives, benefits or features disclosed in the invention. In addition, the title and the written contents in the summary section are only intended for assisting the patent search, and are not meant to be limiting the scope of the invention.

What is claimed is:

1. An illumination system, comprising:
a first light-emitting-diode lamp; and
a first driving device with a communication function coupled to the first light-emitting-diode lamp, and configured to receive a first control signal corresponding to the first light-emitting-diode lamp via wired or wireless manner, and to accordingly provide a first working parameter of the first light-emitting-diode lamp.

2. The illumination system as claimed in claim 1, further comprising:
an electronic equipment with a communication function and having a built-in interactive application, wherein the electronic equipment receives a first user input command in response to an activation of the interactive application, and converts the first user input command to generate the first control signal,
wherein the electronic equipment transmits the first control signal to the first driving device via wired or wireless manner.

3. The illumination system as claimed in claim 2, wherein the first working parameter comprises a first adjustable working voltage and a first adjustable working current, and the first driving device comprises:
a first constant voltage supplying unit configured to receive an AC voltage, and to convert the AC voltage to provide a DC constant voltage;
a first constant current supplying unit configured to receive the DC constant voltage, and to convert the DC constant voltage to provide the first adjustable working voltage and the first adjustable working current of the first light-emitting-diode lamp;
a first communication module configured to receive the first control signal via wired or wireless manner; and
a first control unit coupled to the first constant voltage supplying unit, the first constant current supplying unit and the first communication module, and configured to control operations of the first constant voltage supplying unit and the first constant current supplying unit in response to the first control signal received by the first communication module.

4. The illumination system as claimed in claim 3, further comprising:
a second light-emitting diode lamp coupled to the first driving device,
wherein the first driving device is further configured to receive a second control signal corresponding to the second light-emitting diode lamp via wired or wireless manner, and to accordingly provide a second working parameter of the second light-emitting diode lamp.

5. The illumination system as claimed in claim 4, wherein:
the electronic equipment is further configured to receive a second user input command in response to the activation of the interactive application, and converts the second user input command to generate the second control signal; and
the electronic equipment further transmits the second control signal to the first driving device via wired or wireless manner.

6. The illumination system as claimed in claim 5, wherein the second working parameter comprises a second adjustable working voltage and a second adjustable working current, and the first driving device further comprises:
a second constant current supplying unit configured to receive the DC constant voltage, and to convert the DC constant voltage to provide the second adjustable working voltage and the second adjustable working current of the second light-emitting diode lamp,
wherein the first communication module is further configured to receive the second control signal via wired or wireless manner,
wherein the first control unit is further coupled to the second constant current supplying unit and configured to control an operation of the second constant current supplying unit in response to the second control signal received by the first communication module.

7. The illumination system as claimed in claim 6, wherein:
the first light-emitting-diode lamp comprises a first sensor configured to sense a state of the first light-emitting-diode lamp, and to accordingly provide a first state parameter of the first light-emitting-diode lamp to the first control unit;
the second light-emitting diode lamp comprises a second sensor configured to sense a state of the second light-emitting diode lamp, and to accordingly provide a second state parameter of the second light-emitting diode lamp to the first control unit; and
the first control unit transmits, through the first communication module, the received first state parameter and/or the received second state parameter to the electronic equipment via wired or wireless manner, so as to make that the electronic equipment is capable of monitoring the state of the first light-emitting diode lamp and/or the state of the second light-emitting diode lamp.

8. The illumination system as claimed in claim 6, wherein the first control unit controls the operations of the first constant voltage supplying unit, the first constant current supplying unit and the second constant current supplying unit by adopting an analog manner and/or a digital manner.

9. The illumination system as claimed in claim 3, further comprising:
a second light-emitting diode lamp; and
a second driving device with a communication function coupled to the second light-emitting diode lamp, and configured to receive a second control signal corresponding to the second light-emitting diode lamp via wired or wireless manner, and to accordingly provide a second working parameter of the second light-emitting diode lamp.

10. The illumination system as claimed in claim 9, wherein:
the electronic equipment further receives a second user input command in response to the activation of the interactive application, and to convert the second user input command to generate the second control signal; and
the electronic equipment further transmits the second control signal to the second driving device via wired or wireless manner.

11. The illumination system as claimed in claim 10, wherein the second working parameter comprises a second adjustable working voltage and a second adjustable working current, and the second driving device comprises:
a second constant voltage supplying unit configured to receive the AC voltage, and to convert the AC voltage to provide the DC constant voltage;
a second constant current supplying unit configured to receive the DC constant voltage, and to convert the DC constant voltage to provide the second adjustable working voltage and the second adjustable working current of the second light-emitting diode lamp;
a second communication module configured to receive the second control signal via wired or wireless manner; and
a second control unit coupled to the second constant voltage supplying unit, the second constant current supplying unit and the second communication module, and configured to control operations of the second constant voltage supplying unit and the second constant current supplying unit in response to the second control signal received by the second communication module.

12. The illumination system as claimed in claim 11, wherein:
the first light-emitting-diode lamp comprises a first sensor configured to sense a state of the first light-emitting-diode lamp, and to accordingly provide a first state parameter of the first light-emitting-diode lamp to the first control unit;
the second light-emitting diode lamp comprises a second sensor configured to sense a state of the second light-emitting diode lamp, and to accordingly provide a second state parameter of the second light-emitting diode lamp to the second control unit;
the first control unit transmits, through the first communication module, the received first state parameter to the electronic equipment via wired or wireless manner, so as to make that the electronic equipment is capable of monitoring the state of the first light-emitting-diode lamp; and
the second control unit transmits, through the second communication module, the received second state parameter to the electronic equipment via wired or wireless manner, so as to make that the electronic equipment is capable of monitoring the state of the second light-emitting diode lamp.

13. The illumination system as claimed in claim 11, wherein the second control unit controls the operations of the second constant voltage supplying unit and the second constant current supplying unit by adopting an analog manner and/or a digital manner.

14. The illumination system as claimed in claim 9, wherein the electronic equipment comprises a smart phone, a notebook or a tablet PC.

15. The illumination system as claimed in claim 14, wherein the electronic equipment communicates with the first driving device and/or the second driving device at least via a Bluetooth wireless transmission, a WiFi wireless transmission, a WiMAX wireless transmission, a Zigbee wireless transmission, an infrared ray wireless transmission, a USB wired transmission, or a combination therebetween.

16. The illumination system as claimed in claim 10, wherein the first user input command and/or the second user input command at least comprise at least one of a voice command, a touch command, a gesture command, and a direction sensing command.

17. The illumination system as claimed in claim 5, wherein the first user input command and/or the second user input command at least comprise at least one of a voice command, a touch command, a gesture command, and a direction sensing command.

18. The illumination system as claimed in claim 6, wherein:
the first driving device is capable of being integrated into a power module of the first light-emitting-diode lamp and the second light-emitting diode lamp.

19. The illumination system as claimed in claim 11, wherein:
the first driving device is capable of being integrated into a power module of the first light-emitting-diode lamp; and
the second driving device is capable of being integrated into a power module of the second light-emitting diode lamp.

20. The illumination system as claimed in claim 11, wherein the activated interactive application is further configured to assign corresponding wireless network IP addresses to the first and the second light-emitting diode lamps through a wireless Internet, such that at least one of the first and the second light-emitting diode lamps to be manipulated is selected via the electronic equipment for setting.

21. The illumination system as claimed in claim 11, wherein the first and the second light-emitting diode lamps are two original wireless network devices within a service range covered by a wireless network equipment, and when the electronic equipment becomes as a new wireless network device within the service range covered by the wireless network equipment, the electronic equipment is firstly connected to the wireless network equipment, and then connected, via the wireless network equipment, to at least one of the first and the second light-emitting diode lamps to be manipulated for setting.
